(19) United States
(12) Patent Application Publication
(10) Pub. No.: US 2021/0114766 A1
(43) Pub. Date: Apr. 22, 2021

(54) TRAY AND METHOD FOR ITS ASSEMBLY

(71) Applicant: Intercontinental Great Brands LLC, East Hanover, NJ (US)

(72) Inventors: Jaswinder Dhadda, Toronto (CA); Matthew Pham, Champaign, IL (US)

(21) Appl. No.: 17/254,703

(22) PCT Filed: Jul. 1, 2019
(86) PCT No.: PCT/US2019/040079

§ 371 Date: Dec. 21, 2020

Related U.S. Application Data
(60) Provisional application No. 62/694,905, filed on Jul. 6, 2018.

(51) Int. Cl. B65D 5/48; B65D 71/46; B31B 50/26

(52) U.S. Cl. CPC B65D 5/48014; B65D 71/46; B31B 2120/20; B65D 2571/0037; B65D 2571/0066; B31B 50/26

(57) ABSTRACT

A tray (10) is provided for supporting a plurality of articles (8), such as cartons, where the tray (10) is configured for supporting one or more additional like trays in a stacking arrangement. The tray (10) includes a generally rectangular base (20) and a centrally-located, upstanding divider (30). The divider (30) can be configured to bear compressive loads when one or more like trays with articles are stacked, and the divider (30) having planar sides facing adjacent front and rear ends of the base (20). To help support the divider, a pair of braces (50, 60) extend from the divider (30), with one on each end of the divider (30), to the base (20).

### FIELD

A tray for articles, such as cartons, is described herein and, in particular, a tray having an upstanding, centrally-disposed divider.

### BACKGROUND

When a stack of articles, such as cartons, such as may contain food, is provided, the cartons alone bear the weight of the cartons stacked above. Slip sheets can be provided between layers, and can have upturned edges, but such slip sheets do not change the fact that the cartons are bearing the compressive loads.

A stackable container formed from a single piece of corrugated material is disclosed in U.S. Pat. No. 5,839,650. The container is divided by a partition. However, the planar sides of the partition face closed ends of the container, thereby restricting removal of the items from the container in a direction perpendicular to the partition.

Another container is disclosed in U.S. Pat. No. 6,513,705. An optional divider, formed from a separate piece of material, can be inserted into the container. However, leg portions of the divider are spaced inward from adjacent ends of the container. This inward spacing of the leg portions of the divider would reduce the usable space of the container. Moreover, the divider is a separate component from the container, thereby complicating assembly.

U.S. Patent Publ. No. 2008/0110789 discloses a container with two compartments that is formed from a single blank. The two compartments can be folded such that they face the same direction. As such, central panels lack any sort of brace toward the front, open end of the container. Furthermore, the central panels each have planar faces directed at substantially closed ends of the container.

### SUMMARY

A tray for cartons is described herein, with the tray having a base with an upstanding central divider. Planar sides of the divider face open ends of the tray. A brace extends between each end of the divider and adjacent ends of the tray.

To provide compressive strength, a partitioning tray is provided with an upstanding central divider. The divider has planar sides which each face toward ends of the tray. While those open ends and, optionally, the sides can have an upturned lip, the ends are open in the sense that cartons can easily be removed from the tray via those open ends. Advantageously, the open ends, which may or may not include an upturned lip, permit the contained articles, such as cartons, to be viewable and removable from both the front end and the rear end of the tray.

The central divider is supported on each end by a brace extending between ends of the lower portion and the upstanding central divider. The braces face in opposite directions. The central divider helps bear compressive loads. The central divider also helps with reducing rubbing between adjacent cartons, which rubbing can lead to carton ink wearing off or otherwise marring of the ink forming the graphics on the carton.

Advantageously, the partitioning tray can be formed of a single strip of material, such as corrugated cardboard. Optionally, the corrugations can be registered i.e., the corrugations can be in different directions in different parts of the tray to maximize the benefit of the corrugations. For example, the corrugations can be arranged on the central divider such that they extend vertically, or perpendicular relative to the base.

In one aspect, a tray for a plurality of cartons is provided with a base and an upstanding, centrally-located divider supported at each end by an adjacent one of a pair of braces. The base can be generally rectangular, having a front end, a rear end opposite the front end, a first side extending between the front and rear ends, and, opposite the first side, a second side extending between the front and rear ends, the front and rear ends being open to facilitate removal of a carton or other item from the tray. The centrally-located, upstanding divider, optionally positioned on top of the base, extends between the first and second sides of the base. The divider has a first end adjacent the first side of the base and a second end adjacent the second side of the base. The divider can be configured, such as by having a suitable height, to bear compressive loads when one or more like trays with cartons are stacked. For example, the divider can have a height equivalent to or only very slightly taller, e.g., 2 mm, 5 mm or so, than the height of the articles. The divider can have planar sides facing adjacent front and rear ends of the base. The pair of braces can include a first brace connected to and extending between the first end of the divider and the adjacent first side of the base. The pair of braces can also include a second brace connected to and extending between the second end of the divider and the adjacent second side of the base. The first and second braces are configured to support the divider at each end thereof by helping to maintain the divider in its upright orientation relative to the base.

The divider optionally can be attached to the pair of braces, as opposed to the base. That is, the divider is unattached to the base, instead being attached to the braces.

In one optional aspect, the first and second braces predominately extend in opposite directions. The first and second braces can optionally each include a generally triangular segment.

In another optional aspect, the first brace has a bottom edge that is connected to the first side of the base about a first base fold, and the second brace has a bottom edge that is connected to the second side of the base about a second base fold. The first brace can be connected to the first end of the divider about a first divider fold, and the second brace can be connected to the second end of the divider about a second divider fold.

In yet another optional aspect, the first and second braces each include segments that are folded about a brace fold such that they abut. For example, the first brace can include segments that are folded about a first brace fold such that they abut, and the second brace can include segments that are folded about a second brace fold such that they abut. The first brace fold can be generally parallel to the first divider fold, and the second brace fold can be generally parallel to the second divider fold. The first and second brace folds can optionally be disposed on opposite sides of the divider. The segments of the first brace that are folded about the first brace fold can include a first brace minor segment extending from the first end of the divider toward the front end of the base, and a first brace major segment extending from the first brace fold toward the rear end of the base; and the segments of the second brace that are folded about the second brace fold can include a second brace minor segment extending from the second end of the divider toward the rear end of the base, and a second brace major segment extending from the second brace fold toward the front end of the base. Optionally, the first brace minor segment can be shorter than the firm brace major segment, and the second brace minor segment can be shorter than the second brace major segment.

In any of the aspects described herein, the front and rear ends of the base can be lipless such that a carton on the tray can be slid forward off the base in a direction generally perpendicular to a generally planar face of the divider. Alternatively, a lip can be provided at only the front and rear ends, or, in yet another alternative, a lip can be provided at the front and rear ends and some or all of the sides.

In any of the aspects described herein, the divider can be generally planar and can include two panels attached at a divider joint.

In any of the aspects described herein, the tray is assembled from a unitary piece of paperboard or cardboard.

In any of the aspects described herein, the divider and braces have a generally z-shaped arrangement, with the braces each intersecting the divider at angles that are optionally about 90 degrees or otherwise generally perpendicular. Such a z-shaped arrangement can contribute to a stable platform for stacking of one loaded tray upon another.

A method of assembling a tray described herein can include the steps of providing a single strip of material, and folding the strip of material into the tray.

Optionally, the divider can include first and second divider panels each having one end attached to the adjacent brace and an opposite free end, the method further comprising attaching the free ends of the first and second divider panels to each other.

### BRIEF DESCRIPTION OF THE FIGURES

FIG. 1 is a right side perspective view of a first embodiment of a tray for cartons having an upstanding central divider, showing cartons disposed on the tray on both sides of the divider;

FIG. 2 is a left side perspective view of the tray and cartons of FIG. 1;

FIG. 3 is a top plan view of the tray and cartons of FIG. 1;

FIG. 4 is a right side perspective view of the tray of FIG. 1, but shown without the cartons thereon;

FIG. 5 is a top plan view of the tray of FIG. 1, but shown without the cartons thereon;

FIG. 6 is a right side perspective view of a second embodiment of a tray for cartons having an upstanding central divider; showing cartons disposed on the tray on both sides of the divider;

FIG. 7 is a left side perspective view of the tray and cartons of FIG. 6;

FIG. 8 is a top plan view of the tray and cartons of FIG. 6;

FIG. 9 is a right side perspective view of the tray of FIG. 6, but shown without the cartons thereon;

FIG. 10 is a top plan view of the tray of FIG. 6, but shown without the cartons thereon;

FIG. 11 is a top plan view of a blank for forming the tray of FIGS. 6-10;

FIGS. 12A-12D is a top plan view of the blank of FIG. 11 being sequentially folded into the tray of FIGS. 6-10;

FIG. 13 is a right side perspective view of a third embodiment of a tray for cartons having an upstanding central divider, showing cartons disposed on the tray on both sides of the divider;

FIG. 14 is a left side perspective view of the tray and cartons of FIG. 13,

FIG. 15 is a top plan view of the tray and cartons of FIG. 13;

FIG. 16 is a right side perspective view of the tray of FIG. 13, but shown without the cartons thereon;

FIG. 17 is a top plan view of the tray of FIG. 13, but shown without the cartons thereon;

FIG. 18 is a top plan view of a blank for forming the tray of FIGS. 13-17; and

FIGS. 19A-19D is a top plan view of the blank of FIG. 18 being sequentially folded into the tray of FIGS. 13-17.

It will be understood that the thickness of the tray material in certain views has been exaggerated for clarity. The actual thickness of the tray can vary.

### DETAILED DESCRIPTION

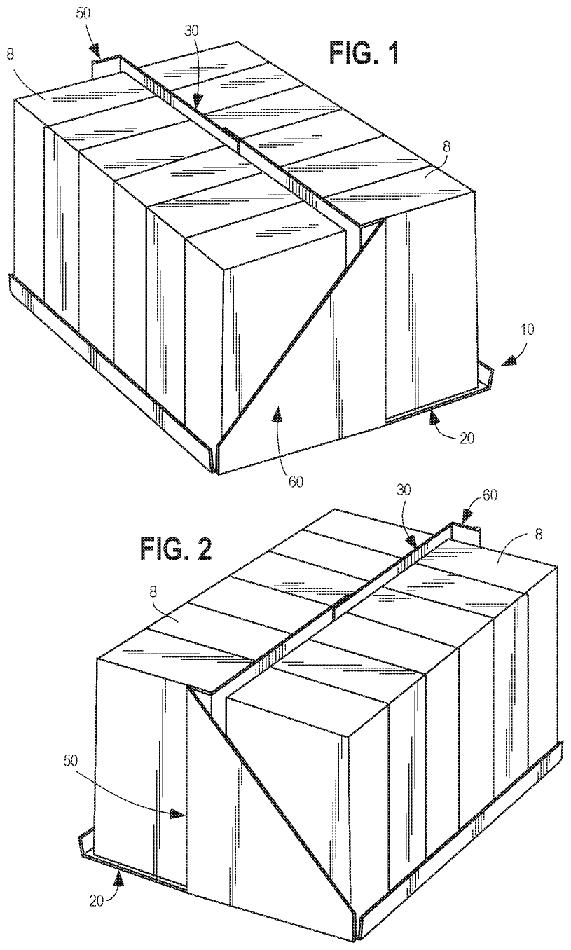

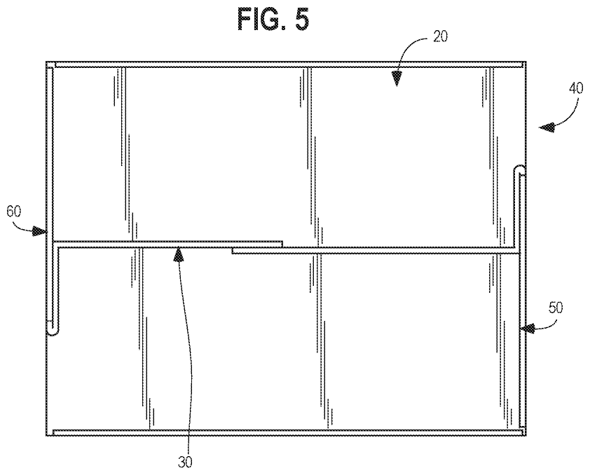

A first embodiment of a tray 10 for cartons 8 is described herein and depicted in FIGS. 1-5, with the tray 10 having a base 20 and an upstanding central divider 30. Planar sides 32, 34 of the divider 30 face open or substantially open ends 12, 14 at the front and rear ends 22, 24 of the base 20 of the tray 10. A brace 50, 60 extends between each end 36, 38 of the divider 30 and adjacent sides 26, 28 of the base 20 of the tray 10 to help support the divider 30 in the upright position. Cartons 8 can be stacked on the base 20, such as during transportation. The divider 30 advantageously helps with bearing compressive loads, such as when multiple loaded trays 10 are stacked. The divider 30 also advantageously can reduce frictional rubbing between adjacent cartons 8 on either side of the divider 30. Because the ends of the tray 12, 14 that faces 32, 34 of the divider 30 are directed toward are open or substantially open, cartons 8 can easily be removed from the tray 10.

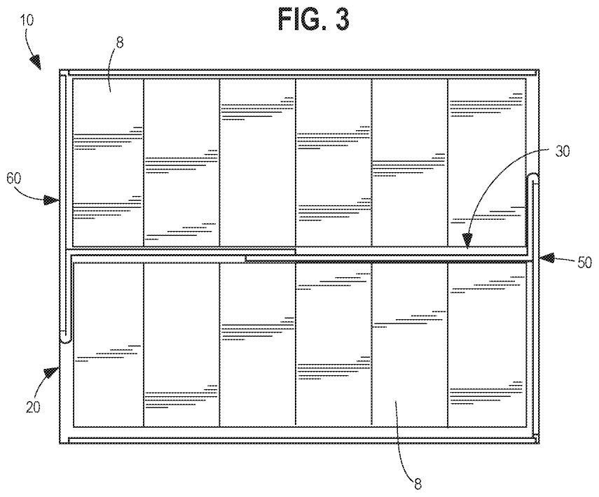

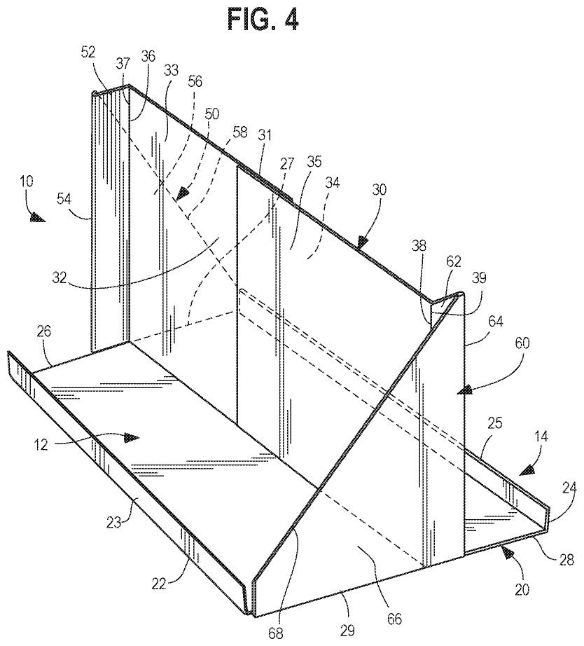

Turning to details of the tray 10, as mentioned above the tray includes a base 10 and an upstanding, central divider 30. The divider 30 is supported in its upright position by a pair of braces 50, 60, with a brace 50, 60 disposed at each end 36, 38 of the divider 30. When the tray 10 is assembled, the base 20 is generally rectangular, as shown in FIGS. 3 and 4. The base 20 has a front end 22 and an opposite rear end 24, with the divider 30 being positioned between the front and rear ends 22, 24. The base 20 also has a first side 26 and an opposite second side 28. When assembled, the divider 30 is generally planar, having a first face 32 directed toward the front end 22 of the base 20 and a second face 34 directed toward the rear end 24 of the base 20.

Optionally, the front and/or rear ends 22, 24 of the base 20 are open or lipless such that a carton 8 on the tray 10 can be slid forward off the base 20 in a direction generally perpendicular to a generally planar face of the divider 30. As shown in FIGS. 1-5, the front and rear ends 22, 24 can each include an upturned panel 23, 25 that is free to pivot about its intersection with the front and rear ends 22, 24, which is considered to be open or lipless. Yet another option is for the base 20 to simply terminate at free, coplanar or substantially coplanar edges of the front and rear ends 22, 24, which also is considered open.

The divider 30 is preferably, though not necessarily, unconnected to the base 20. Instead, the divider 30 is connected to the base 20 via the braces 50, 60. More specifically, a first brace 50 extends between a first end 36 of the divider 30 and the first side 22 of the base 20 of the tray 10, as shown in FIG. 4. Similarly, a second brace 60 extends between a second end 38 of the divider 30 and the second side 24 of the base 20 of the tray 10, also as shown in FIG. 4. The divider 30 can be formed of a first divider panel 33 attached at a joint 31 to a second divider panel 35. The joint 31 can be disposed between the first and second braces 50 and 60. The joint 31 can be a lap joint, as shown in the figures. Alternatively, the joint can be in an abutting arrangement.

In the exemplary, but non-limiting embodiment shown in the figures, the first brace 50 is connected to the first side 26 of the base 20 of the tray 10 about a first brace fold 27, and the first end 36 of the divider 30 is connected to the first brace 50 about a first divider fold 37. Similarly, the second brace 60 is connected to the second side 28 of the base 20 of the tray 10 about a second brace fold 29, and the second end 38 of the divider 30 is connected to the second brace 60 about a second divider fold 39.

The braces 50, 60 generally face in different directions. That is, the first brace 50 is predominately positioned toward the rear end 24 of the base 20 of the tray 10, and the second brace 60 is predominately positioned toward the front end 22 of the base 20 of the tray 10. In other words, the first brace 50 is attached to a greater portion along the first side 26 of the base 20 of the tray 10 on one side of the divider 30 as compared to on the opposite side of the divider 30. Likewise, the second brace 60 is attached to a greater portion along the second side 28 of the base 20 of the tray 10 on a different side of the divider 30, relative to the first brace 50, as compared to on the opposite side of the divider 30. Alternatively, the braces 50, 60 can be attached to the entirety or substantially the entirety of their respective sides 26, 28, as discussed further below.

Turning to other details of the braces 50, 60, each brace 50, 60 can optionally include a pair of segments folded to abut each other about an associated brace fold. In particular, and with reference to the non-limiting, exemplary embodiment shown in the figures, the first brace 50 includes a first brace minor segment 52 extending from the first end 36 of the divider 30 to a first brace fold 54 positioned toward the front end 22 of the base 20 relative to the divider 30. The first brace 50 also including a first brace major segment 56 extending from the first brace fold 54 toward the rear end 24 of the base 20 relative to the divider 30. Similarly, the second brace 60 includes a second brace minor segment 62 extending from the second end 38 of the divider 30 to a second brace fold 64 positioned toward the rear end 24 of the base 20 relative to the divider 30. The second brace 60 also including a second brace major segment 66 extending from the second brace fold 64 toward the front end 22 of the base 20 relative to the divider 30. As each vertical fold 37, 39, 54, 64 can contribute to greater compressive strength, providing the braces 50, 60 with abutting segments can increase the compressive strength of the tray 10 as compared to if there were no such abutting segments.

As shown in FIGS. 1-5, the first brace minor segment 52 of the first brace 50 extends only a relatively short distance toward the front end 22 of the base 20, and the second brace minor segment 62 of the second brace 60 extends only a relatively short distance toward the rear end 24 of the base 20. Optionally, those minor segments 52, 62 can extend further toward their respective ends 22, 24 of the base 20 or to the ends 22, 24 of the base 20. For example, the first brace fold 27 can extend along the entirety of or substantially the entirety of the length of the first side 26 of the base 20. Likewise, the second brace fold 29 can extend along the entirety of or substantially the entirety of the length of the second side 28 of the base 20. In such examples, the spans of the first brace major segment 56 and second brace major segments 66 will increase as compared to as they are shown in FIGS. 1-5.

The first and second brace major segments 56, 66 can have a generally triangular shape, with an inclined edge 58, 68 extending from the respective first and second brace folds 54, 64 toward the base 20, as shown in the figures. The inclined edge 58, 68 can intersect the base 20 or, as shown in the figures, terminate prior to intersecting the base 20.

Optionally, the first and second brace major segments 56, 66 can each include a pair of panels. More specifically, the first brace major segment 56 can include an inner first brace major segment panel abutting an outer first brace major segment panel, with the inner and outer panels connected via a fold comprising the inclined edge 58. Likewise, the second brace major segment 66 can include an inner second brace major segment panel abutting an outer second brace major segment panel, with the inner and outer panels connected via a fold comprising the inclined edge 68.

When assembled, as shown in FIGS. 1-5, the tray 10 is configured for supported multiple cartons 8 on the base 20. For example, a first array of cartons 8 can be positioned on one side of the divider 30, and a second array of cartons 8 can be positioned on an opposite side of the divider 30 relative to the first array. As mentioned above, in addition to increasing compressive strength of the tray 10, the divider 30 also can beneficially reduce rubbing of adjacent portions of cartons 8, which rubbing can cause ink or other printing to mar.

The tray 10 can be made of any suitable material of sufficient rigidity and foldability, such as paperboard, cardboard (including corrugated cardboard), and plastic sheeting. The tray 10 can also vary in dimensions from those illustrated so as to accommodate different size cartons 8. Indeed, the tray 10 can also be used for items other than cartons 8.

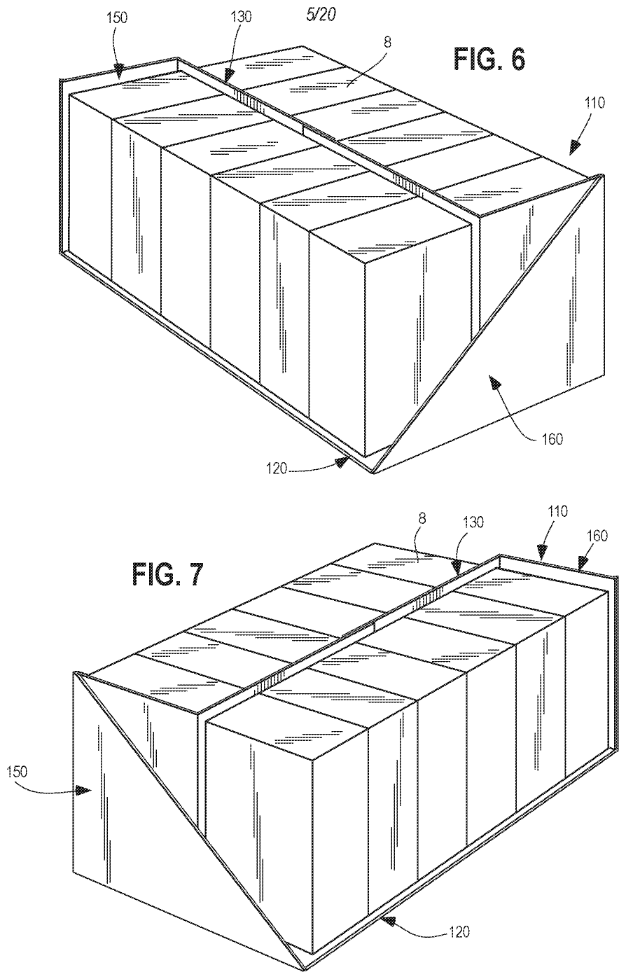

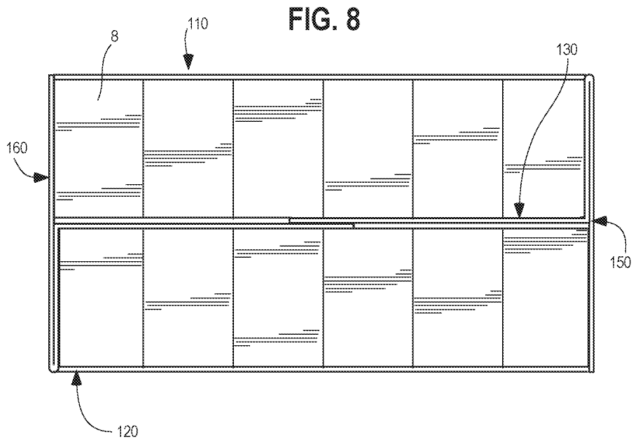

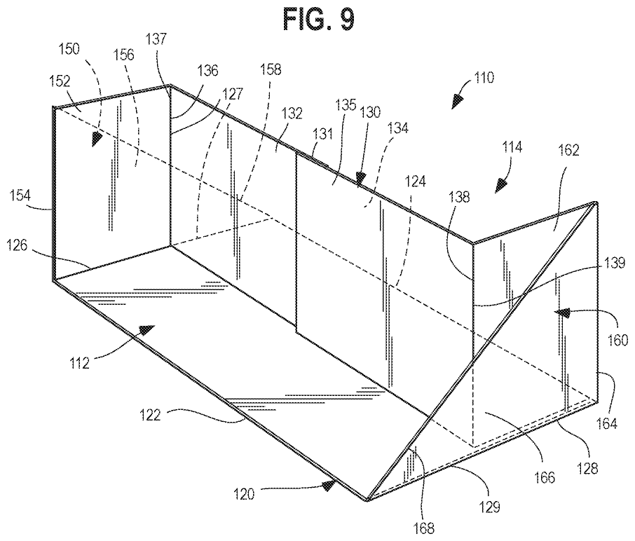

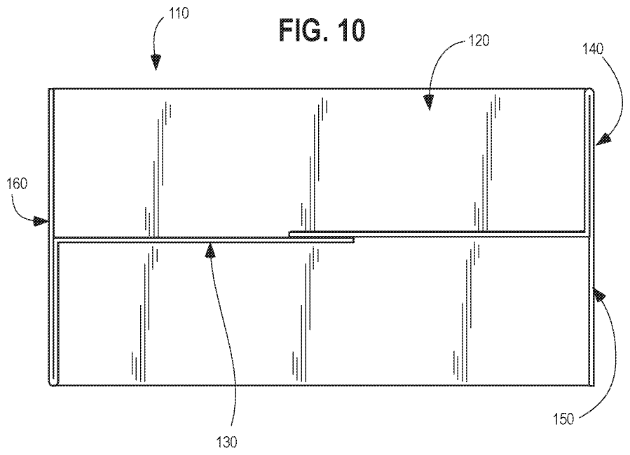

A second embodiment of a tray 110 for cartons 8 or other articles is described herein and depicted in FIGS. 6-10, with the tray 110 having a base 120 and an upstanding central divider 130. For ease of reference, similar components in the first embodiment are referenced in the second embodiment using a proceeding “1”. The tray 110 of the second embodiment lacks the upturned panels 23, 25. The tray 110 of the second embodiment also has a different geometry of its braces 150, 160. More specifically, the first and second brace major segments 56, 66 extend along the entire span of their respective sides 26, 28. Such an arrangement also involves the first and second brace minor segments 152, 162 extending from the central divider 130 to the front and rear edges 122, 124, respectively. This arrangement can provide for greater lateral containment of the articles 8.

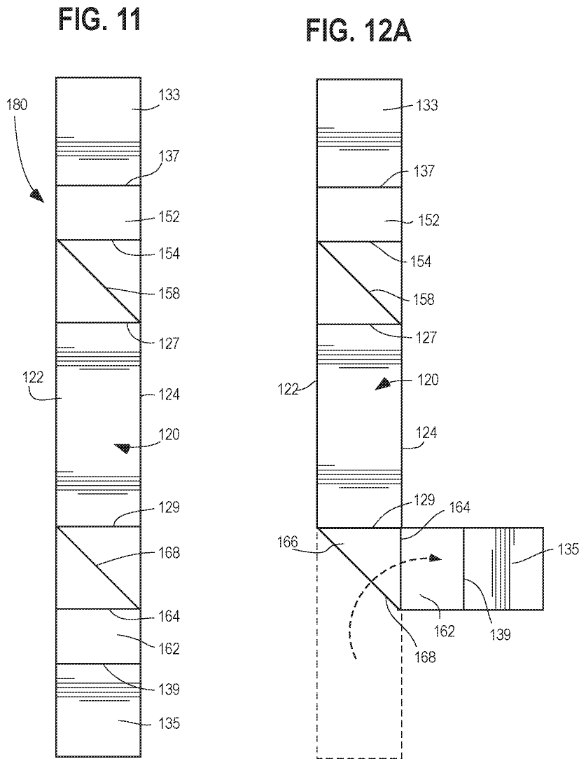

The tray 110 can be formed from a blank 180, such as that shown in FIG. 11. It can be advantageous for the tray 110 to be formed from a single, unitary strip or portion of material, e.g., not formed of multiple pieces of material joined together via adhesive or the like, as shown in FIG. 11. However, the tray 110 can instead be formed from more than one piece of material. Ends of the strip of material can be adhered together with a twist, e.g., the top of a first end can be adhered to the bottom of a second end. While the adhering of the ends can take place after assembly, it is noted that the assembled strip or portion of material can be considered to be akin to a Möbius strip or band.

Turning now to a non-limiting, exemplary method of forming the tray 110 from the blank 180, reference is made to the blank of FIG. 11, which depicts, in order, the first divider panel 133, the first divider fold 137 (between the first divider panel 133 and the first brace minor segment 152), the first brace minor segment 152, the first brace fold 154 (between the first brace major segment 156 and the first brace minor segment 152), the inner panel of the first brace major segment 156, the fold that will comprise the inclined edge 158 of the first brace major segment 156, the outer panel of the first brace major segment 156, the first brace fold 127 (between the first brace major segment 156 and the first side 126 of the base 120), the base 120, the second brace fold 129 (between the second brace major segment 166 and the second side 128 of the base 120), the outer panel of the second brace major segment 166, the fold that will comprise the inclined edge 168 of the second brace major segment 166, the inner panel of the second brace major segment 166, the second brace fold 164 (between the first brace major segment 166 and the second brace minor segment 162), the second brace minor segment 162, the second divider fold 139 (between the second divider panel 135 and the second brace minor segment 162), and the second divider panel 135.

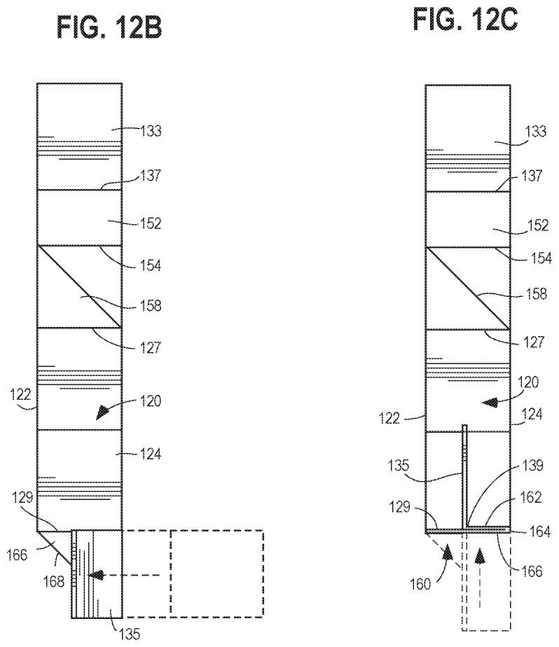

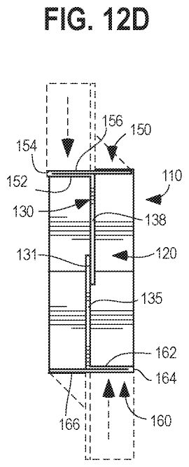

To assemble the tray 110 from the blank of FIG. 11, a non-limiting, exemplary method can include first folding about the fold that will comprise the inclined edge 168, thereby positioning the inner panel of the second brace major segment 166 on top of the outer panel of the second brace major segment 166, as shown in FIG. 12A. The blank 180 can be considered to have a longitudinal central axis in the major length direction. In this arrangement shown in FIG. 12A, the portion of the longitudinal central axis passing through the second brace minor segment 162 and the second divider panel 135 is generally perpendicular to the remaining portion of the longitudinal central axis passing through the base 120. Next, the second brace minor segment 162 can be positioned abutting the inner panel of the second brace major segment 166 by folding about the second brace fold 164, followed by folding about the second divider fold 139, as shown in FIG. 12B. A fold can then be made about the second brace fold 129 to position the second brace minor and major segments 162, 166 and the second divider panel 135 in an upright arrangement, e.g., generally perpendicular, relative to a plane of the base 120, as shown in FIG. 12C. These steps can be followed for the other side to position the first brace minor and major segments 152, 156 and the first divider panel 133 in an upright arrangement relative to the plane of the base 120, as shown in FIG. 12D. More specifically, folding is performed about the fold that will comprise the inclined edge 158, thereby positioning the inner panel of the second brace major segment 156 on top of the outer panel of the second brace major segment 156. Next, the first brace minor segment 152 can be positioned abutting the inner panel of the first brace major segment 156 by folding about the first brace fold 154, followed by folding about the first divider fold 137. A fold can then be made about the first brace fold 217 to position the first brace minor and major segments 152, 156 and the first divider panel 133 in the upright arrangement relative to a plane of the base 120, as shown in FIG. 12D. Overlapping portions of adjacent ends of the first and second divider panels 133, 135 can be adhered together, such as by using an adhesive, to form the joint 131. Optionally, the joint 131 can be the only part of the tray that includes adhesive or joining. It will be understood that the foregoing folding steps can be performed in a variety of orders and orientations that will result in the tray.

The tray formed from the blank 180 of FIG. 11, and shown in the steps of FIGS. 12A-12D, is different from the tray 110 depicted in FIGS. 6-10. As explained above, the tray formed of the blank 180 of FIG. 11 differs in that it lacks the upturned panels 23, 25 associated with the front and rear ends 22, 24, respectively, of the tray 10 shown in FIGS. 1-5. Also by way of example, the tray formed of the blank 180 of FIG. 11 differs in that the first brace fold 127 extends along the entirety of the length of the first side 126 of the base 120 and, similarly, the second brace fold 129 extends along the entirety of the length of the second side 128 of the base 120, as compared to the spans of the first brace major segment 156 and second brace major segments 166 will increase as compared to as they are shown in FIGS. 1-5.

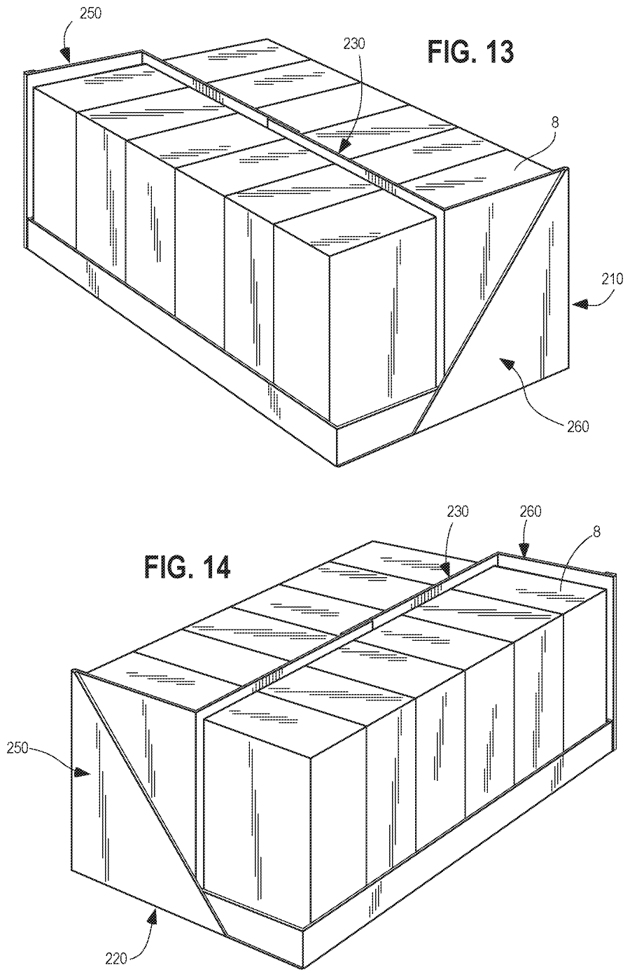

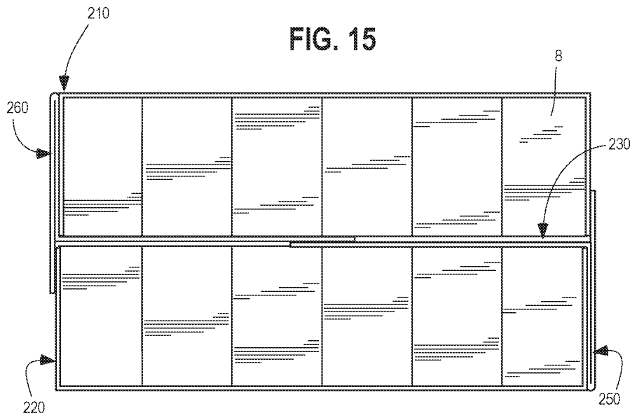

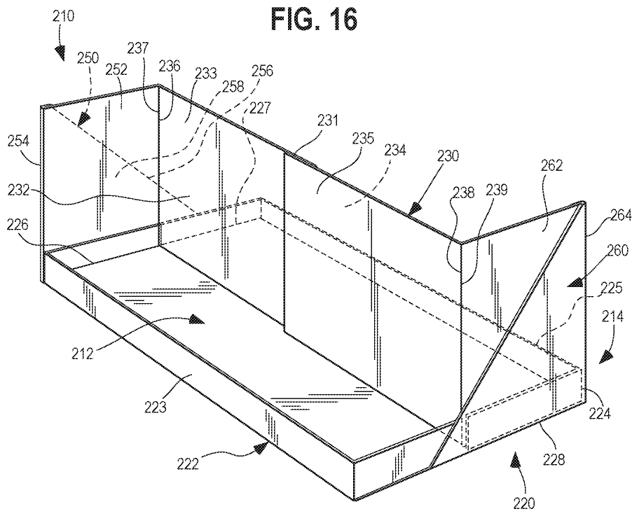

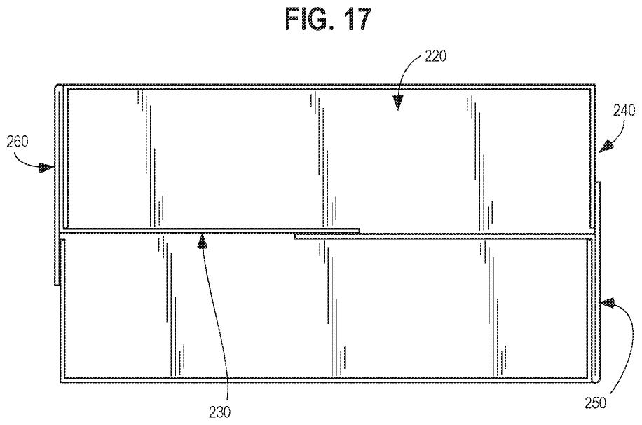

A third embodiment of a tray 210 for cartons 8 or other articles is described herein and depicted in FIGS. 13-17, with the tray 210 having a base 220 and an upstanding central divider 230. For ease of reference, similar components in the first embodiment are referenced in the second embodiment using a proceeding “2”. The tray 210 of the third embodiment has a lip not only in the front and rear, but also on the sides. The tray 210 of the third embodiment also has a different geometry of its braces 250, 260. More specifically, the first and second brace minor segments 252, 262 extending from the central divider 230 to the front and rear edges 222, 224, respectively. This arrangement can provide for greater lateral containment of the articles 8.

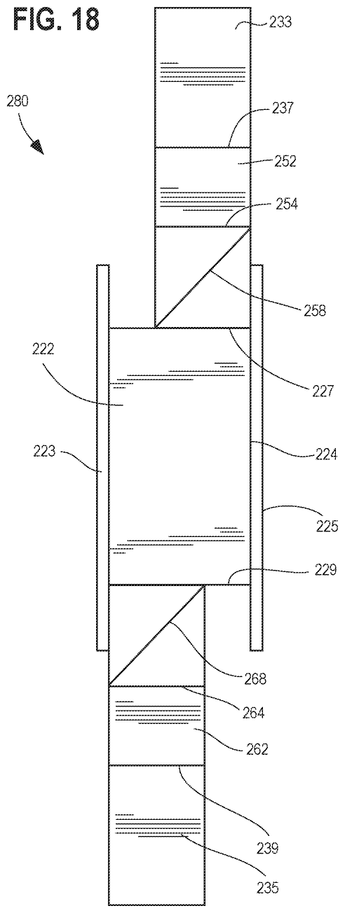

Turning now to another non-limiting, exemplary method of forming the tray 210 from the blank 280, reference is made to the blank of FIG. 18, which depicts, in order, the first divider panel 233, the first divider fold 237 (between the first divider panel 233 and the first brace minor segment 252), the first brace minor segment 252, the first brace fold 254 (between the first brace major segment 256 and the first brace minor segment 252), the inner panel of the first brace major segment 256, the fold that will comprise the inclined edge 258 of the first brace major segment 256, the outer panel of the first brace major segment 256, the first brace fold 227 (between the first brace major segment 256 and the first side 226 of the base 220), the base 220, the second brace fold 229 (between the second brace major segment 266 and the second side 228 of the base 220), the outer panel of the second brace major segment 266, the fold that will comprise the inclined edge 268 of the second brace major segment 266, the inner panel of the second brace major segment 266, the second brace fold 264 (between the first brace major segment 266 and the second brace minor segment 262), the second brace minor segment 262, the second divider fold 239 (between the second divider panel 235 and the second brace minor segment 262), and the second divider panel 235.

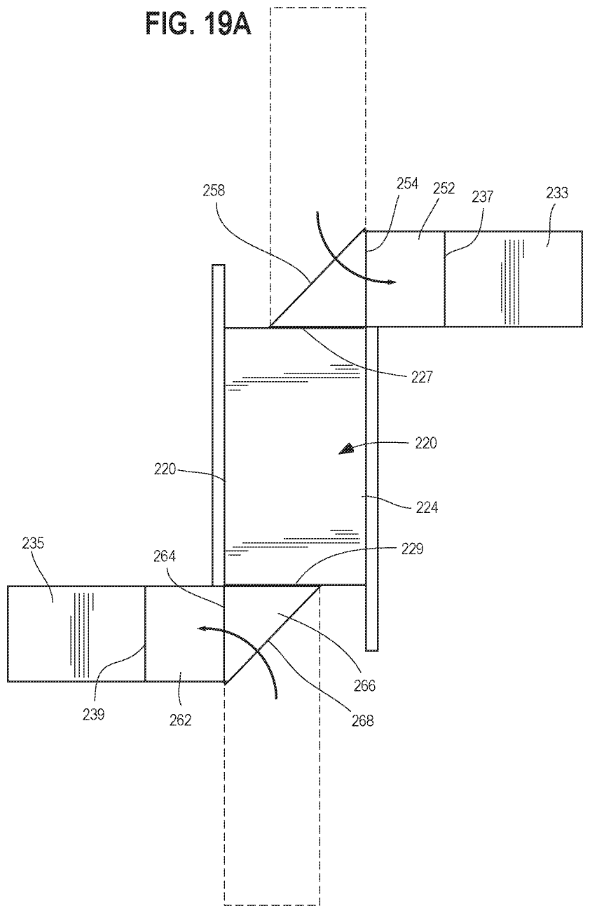

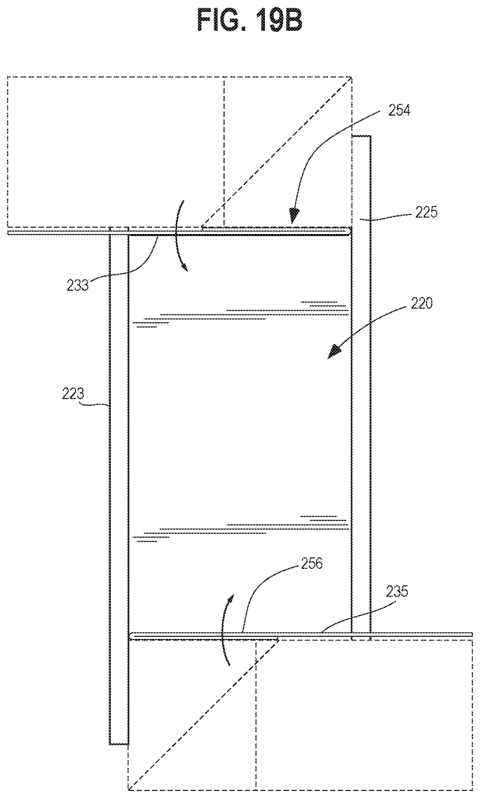

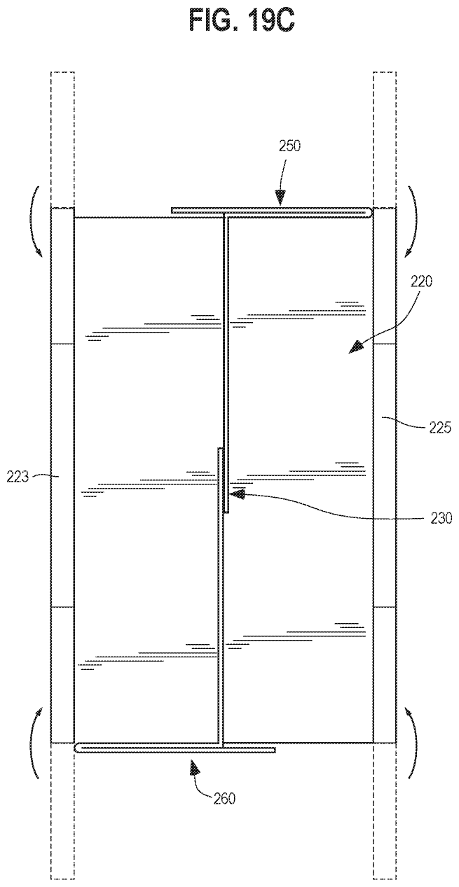

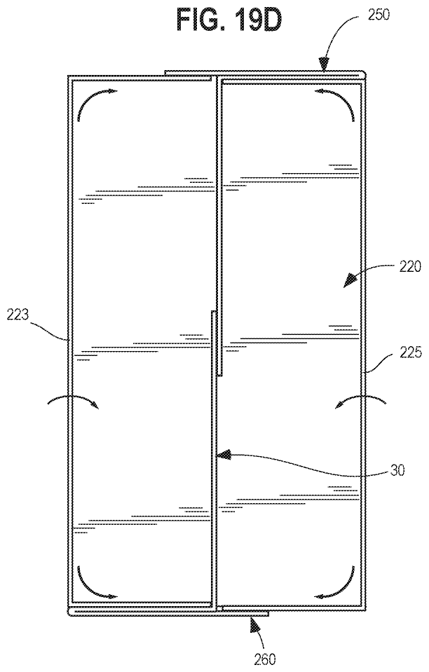

To assemble the tray 210 from the blank 280 of FIG. 18, a non-limiting, exemplary method can include first folding about the fold that will comprise the inclined edge 268, thereby positioning the inner panel of the second brace major segment 266 on top of the outer panel of the second brace major segment 266, as shown in FIG. 18A. The blank 280 can be considered to have a longitudinal central axis in the major length direction. In this arrangement shown in FIG. 18A, the portion of the longitudinal central axis passing through the second brace minor segment 262 and the second divider panel 235 is generally perpendicular to the remaining portion of the longitudinal central axis passing through the base 220. Next, the second brace minor segment 262 can be positioned abutting the inner panel of the second brace major segment 266 by folding about the second brace fold 264, followed by folding about the second divider fold 239, as shown in FIG. 19B. A fold can then be made about the second brace fold 229 to position the second brace minor and major segments 262, 266 and the second divider panel 235 in an upright arrangement, e.g., generally perpendicular, relative to a plane of the base 220, as shown in FIG. 19C. These steps can be followed for the other side to position the first brace minor and major segments 252, 256 and the first divider panel 233 in an upright arrangement relative to the plane of the base 220, as shown in FIG. 12C. Overlapping portions of adjacent ends of the first and second divider panels 233, 235 can be adhered together, such as by using an adhesive, to form the joint 231. Optionally, the joint 231 can be the only part of the tray that includes adhesive or joining. It will be understood that the foregoing folding steps can be performed in a variety of orders and orientations that will result in the tray. The upturned panels 223, 225 and the side upturned panels 223′, 225′ can be folded into an upright orientation, generally perpendicular relative to a plane of the base, as shown in FIG. 19D, so as to contribute to defining a raised lip of the base 220.

As mentioned above, the tray 210 formed from the blank 280 of FIG. 18 is different from the tray 110 depicted in FIGS. 6-10. For example, the tray 210 formed of the blank 280 of FIG. 18 differs in that it includes upturned panels 223, 225 associated with the front and rear ends 222, 224, respectively, of the base of the tray 210. In addition, each of those upturned panels 223, 225 includes side upturned panels 223′, 225′ at each end thereof connected to the upturned panels 223, 225 via fold lines. The side upturned panels 223′, 225′ and the upturned panels 223, 225 can be joined to form a continuous upturned lip about at least a portion of the base of the tray. Also by way of example, the tray formed of the blank 280 of FIG. 18 differs in that the first and second brace major segments 256, 266, with the generally triangular shape, have their inclined edges 258, 268 directed more toward the mid portion of the base 220 as compared to being directed closed toward the front and rear ends 222, 224 of the base 220. Also by way of example, the first and second minor segments 252, 262 extend from their respective ends 222, 224 of the base 220 the middle portion of the base 220.

1. A tray for a plurality of articles, the tray comprising:
a generally rectangular base having a front end, a rear end opposite the front end, a first side extending between the front and rear ends and, opposite the first side, a second side extending between the front and rear ends;
a centrally-located, upstanding divider positioned on top of the base and extending between the first and second sides of the base, the divider having a first end adjacent the first side of the base and a second end adjacent the second side of the base, and the divider having planar sides facing adjacent front and rear ends of the base; and
a pair of braces including a first brace connected to and extending between the first end of the divider and the adjacent first side of the base and a second brace connected to and extending between the second end of the divider and the adjacent second side of the base, the first and second braces being configured to support the divider at each end thereof.

2. The tray of claim 1, wherein the first and second brace predominately extend in opposite directions.

3. The tray of claim 1, wherein the first and second braces each include a generally triangular segment.

4. The tray of claim 1, wherein the first brace has a bottom edge that is connected to the first side of the base about a first base fold, and wherein the second brace has a bottom edge that is connected to the second side of the base about a second base fold.

5. The tray of any one of claim 1, wherein the first brace is connected to the first end of the divider about a first divider fold, and wherein the second brace is connected to the second end of the divider about a second divider fold.

6. The tray of claim 1, wherein the first and second braces each include segments that are folded about a brace fold such they abut.

7. The tray of claim 5, wherein the first brace includes segments that are folded about a first brace fold such that they abut, and the second brace includes segments that are folded about a second brace fold such that they abut.

8. The tray of claim 7, wherein the first brace fold is generally parallel to the first divider fold, and wherein the second brace fold is generally parallel to the second divider fold.

9. The tray of claim 7, wherein the first and second brace folds are disposed on opposite sides of the divider.

10. The tray of claim 9, wherein:
the segments of the first brace that are folded about the first brace fold include a first brace minor segment extending from the first end of the divider toward the front end of the base, and a first brace major segment extending from the first brace fold toward the rear end of the base; and
the segments of the second brace that are folded about the second brace fold include a second brace minor segment extending from the second end of the divider toward the rear end of the base, and a second brace major segment extending from the second brace fold toward the front end of the base.

11. The tray of claim 9, wherein the first brace minor segment is shorter than the first brace major segment, and the second brace minor segment is shorter than the second brace major segment.

12. The tray of claim 1, wherein the front and rear ends of the base are lipless such that a carton on the tray can be slid forward off the base in a direction generally perpendicular to a generally planar face of the divider.

13. The tray of claim 1, wherein the contained articles are viewable and removable from both the front and rear of the tray as well as vertically.

14. The tray of claim 1, wherein the divider is generally planar and includes two panels attached at a divider joint.

15. The tray of claim 1, wherein the tray is assembled from a unitary piece of paperboard or cardboard.

16. The tray of claim 1, wherein the divider and braces have a generally z-shaped arrangement.

17. The tray of claim 1, wherein the divider has a height, relative to a height of one or more of the articles, sufficient to contribute to bearing compressive loads when one or more like trays with articles are stacked

18. A method of assembling the tray of claim 1, the method comprising:
providing a single strip of material; and
folding the strip of material into the tray.

19. The method of claim 18, wherein the divider includes first and second divider panels each having one end attached to the adjacent brace and an opposite free end, the method further comprising attaching the free ends of the first and second divider panels to each other.
